(19) United States
(12) Patent Application Publication
(10) Pub. No.: US 2024/0214665 A1
(43) Pub. Date: Jun. 27, 2024

(54) ROTATABLE CAMERA FOR POS MACHINE

(71) Applicant: EBN Technology Corp., New Taipei City (TW)

(72) Inventors: FANG-HSIANG TSENG, New Taipei City (TW); YUEH-HUNG WU, New Taipei City (TW); CHIN-PIAO WANG, New Taipei City (TW)

(21) Appl. No.: 18/145,253

(22) Filed: Dec. 22, 2022

(51) Int. Cl. H04N 23/57; G06Q 20/20

(52) U.S. Cl. CPC H04N 23/57; G06Q 20/20

(57) ABSTRACT

A rotatable camera device for a POS machine, comprises: a main display screen and a customer display screen; wherein the customer display screen is located behind the main display screen; a placement position is recessed on the customer display screen to accommodate a camera unit that is pivotally connected in a horizontal direction, so that the camera unit is rotatably located on the customer display screen and has at least a first rotational location and a second rotational location, the first rotational location is located in the same direction as the customer display screen, faces a customer end for sale payment and collection on an image big data; and the second rotational location is located in the same direction as the main display screen, is higher than an upper end of the main display screen and faces a cash register for image recognition and booting.

### BACKGROUND OF THE INVENTION

### Field of the Invention

The present invention discloses the technical field of terminal sale machines, especially a rotatable camera for a POS machine.

### The Prior Arts

The POS machine is also called the sale terminal, (point of service, or point of sale, POS), which is an essential tool for managing cash income. It is mainly used as a multifunctional computer device for commodity retails, restaurants, and business counters. It can be externally connected to devices and other equipment such as printers, magnetic card machines, and code scans. Its functions can calculate the cash register, store the unit price of goods, inventory information, and print sales reports. It is an indispensable basic electronic device for modern and automated business management.

The early traditional point of sale (POS) terminals all included a mainframe, a keyboard and a display screen. The integrated volume was huge, and it was very inconvenient to occupy a lot of space in practical applications. Moreover, the product function expansion was low and could not meet the needs of various customers. A new generation of products has adopted a tablet computer installed on a bracket as a POS (point of sale) machine, which can be greatly reduced in size and has stronger practical functions.

With the development of science and technology, some sale terminals also have the function of paying after scanning a face. However, the cameras of existing POS machines for payment after scanning a face as recognition, that are generally fixed configurations, which limits the shooting angle of the camera, making it difficult to operate and use with consumers of different heights, and its structural design is not yet perfect, which limits its scope of application. It cannot be used to perform image recognition for booting, so further improvement is necessary.

### SUMMARY OF THE INVENTION

In view of this, the main purpose of the invention is to provide a rotatable camera device of a POS machine, which comprises:

A POS machine has a main display screen and a customer display screen, wherein the customer display screen is located behind the main display screen.

A camera unit is rotatably arranged on the customer display screen and has at least a first rotational location and a second rotational location.

The first rotational location is located in the same direction as the customer display screen, faces a customer end for sale payment and collection on an image big data, but the actual function is not limited thereto; and

The second rotational location is located in the same direction as the main display screen, is higher than an upper end of the main display screen and faces a cash register for image recognition and booting, but the actual function is not limited thereto.

In a preferred embodiment, wherein the customer display screen is composed of a VFD (vacuum fluorescent display) or an LCD (liquid crystal screen) for the customer display screen, but it is not limited to this.

In a preferred embodiment, wherein the POS machine is a flat panel POS machine, and the customer display screen is recessed with a placement position to accommodate the horizontal pivoting of the camera unit, the rotational angle between the first rotational location and the second rotational location is at least 180 degrees, but it is not limited to this actually.

Preferably implemented, wherein the camera unit is in the shape of a horizontal bar, and the front of the camera unit is a plane portion on which a camera is installed, and the rear of the camera unit is an arc portion for back and forth rotation, a hinge on one side connected to the placement position and the camera unit, and the sleeve hole on the other side connected to the placement position and the camera unit, a center of the swivel hole is provided for a wiring configuration of the camera, the wiring is pulled out to the POS machine through the outlet hole on the rear of the swivel seat.

Compared with the prior art, the advantage of the rotatable camera device of the creation POS machine is that the structure is simple and practical. The biggest feature is the design that the camera unit can be flipped from front side to back side, wherein the first rotational location is located in the same direction as the customer display screen, faces the customer side to perform sales payment and collection on an image big data, effectively collects and analyzes customer source consumption time, gender, age, purchase information, etc., and allow customers to scan QR CODE for mobile phone payment recognition, etc., and the second rotational location is located in the same direction as the main display screen, faces the cash register to perform image recognition and boot to keep information confidentiality from disclosed. The overall effective design can improve the practicability of the intelligent functions of the POS machine and meet the market demand for modern sales.

### BRIEF DESCRIPTION OF THE DRAWINGS

FIG. 1 is the combined plan of the present invention.

FIGS. 2A,2B are stereogram views of the camera unit and the customer display screen of the present invention.

FIGS. 3A,3B are stereogram views of the camera unit and the customer display screen from another view.

FIG. 4 is an application example diagram of the camera unit located in the second rotational location of the present invention.

FIG. 5 is an application example diagram of the first rotational location of the camera unit of the present invention.

FIG. 6 is a three-dimensional exploded view of the camera unit and the customer display screen of the present invention.

FIG. 7 is a combined perspective view of the camera unit and customer display screen of the present invention.

FIG. 8 is an application example diagram of the LCD (liquid crystal screen) for the customer display screen of the present invention.

FIG. 9 is an example diagram of the application of the folding terminal sale machine of the present invention.

### DETAILED DESCRIPTION OF THE PREFERRED EMBODIMENT

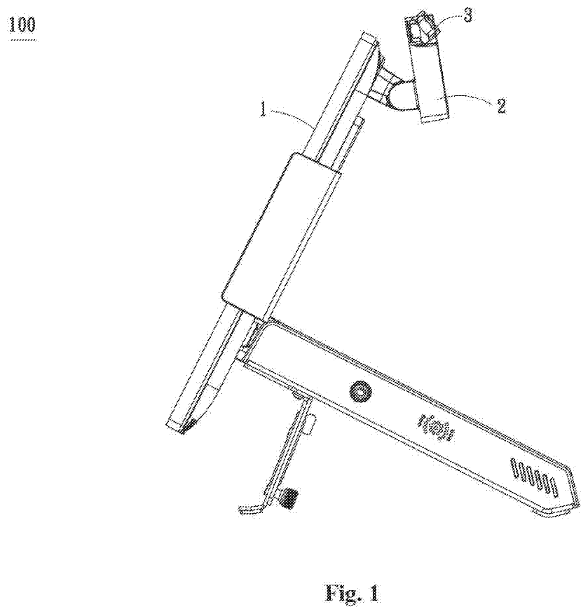

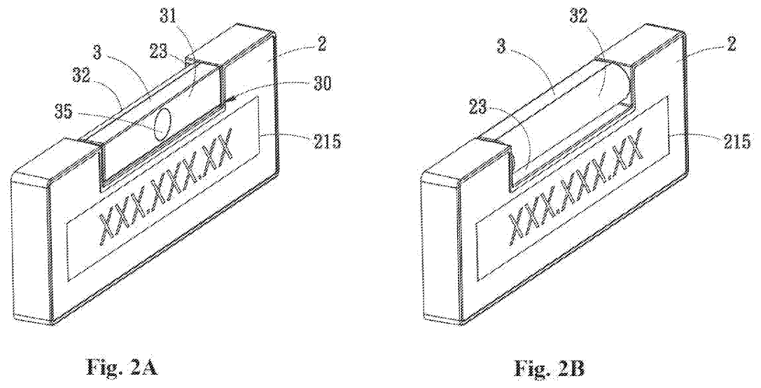

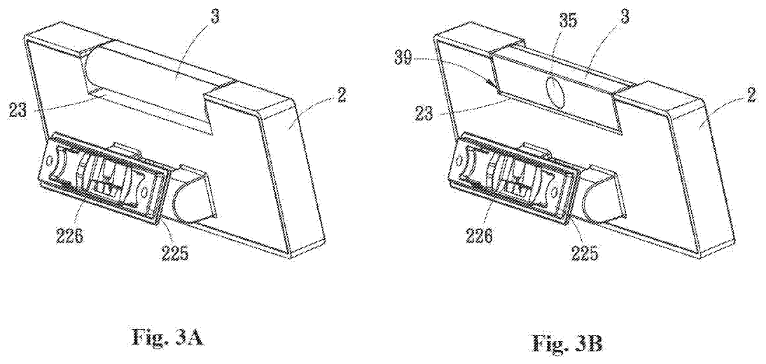

For the convenience of understanding the content of the invention and the effect that can be achieved, the specific embodiments are listed in conjunction with the drawings, and the details are as follows. Please refer to shown in FIGS. 1 to 5, a POS machine 100 disclosed by the present invention, that is a rotatable camera device, comprises:

A POS machine 100 has a main display screen 1 and a customer display screen 2, wherein the customer display screen 2 is located behind the main display screen 1.

A camera unit 3 is rotatably located on the customer display screen 2 and has at least a first rotational location 30 and a second rotational location 39.

The first rotational location 30 is located in the same direction as the customer display screen 2, faces a customer end for sale payment and collection on an image big data, but the actual function is not limited thereto; and

The second rotational location 39 is located in the same direction as the main display screen 1, is higher than an upper end of the main display screen 1 and faces a cash register for image recognition and booting, but the actual function is not limited thereto.

In a preferred embodiment, wherein the POS machine 100 is a flat panel POS machine, and the customer display screen 2 is recessed with a placement position 23 to accommodate the horizontal pivoting of the camera unit 3, the rotational angle between the first rotational location 30 and the second rotational location 39 is at least 180 degrees, but it is not limited thereto.

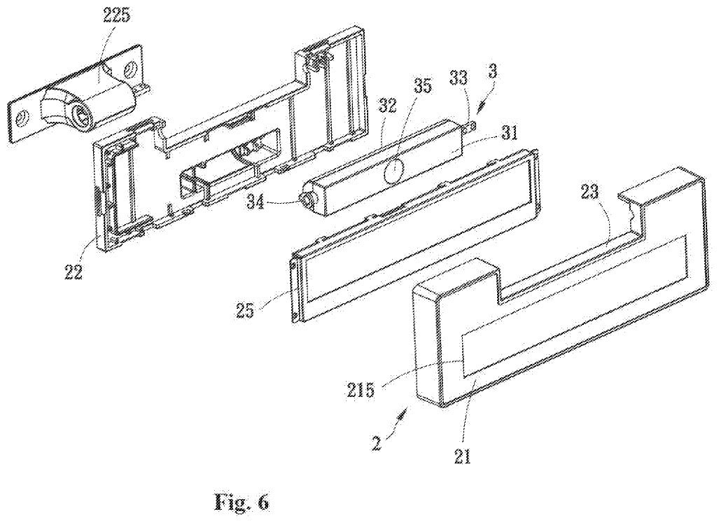

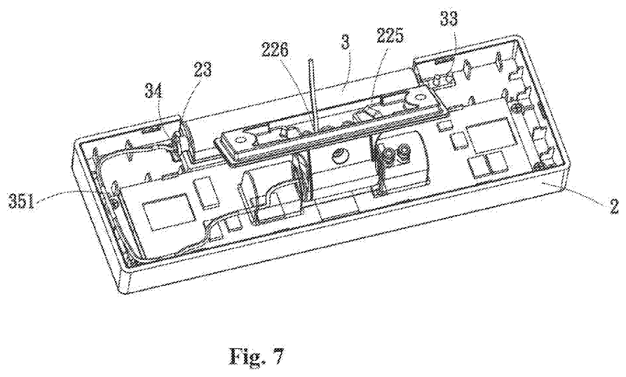

In a preferred embodiment, as shown in FIG. 1, FIG. 6 and FIG. 7, wherein the customer display screen 2 is composed of a front concave cover 21, a rear concave cover 22, and a digital display screen 25 is clamped between the front concave cover 21 and the rear concave cover 22, a display frame 215 on the front concave cover 21 to show the digital display screen 25, and a swivel seat 225 is located on the rear of the rear concave cover 22, so that the swivel seat 225 is rotated on a back of the main display screen 1, and an outlet hole 226 is located on the swivel seat 225 for connecting a wiring.

In a preferred embodiment, wherein the camera unit 3 is in the shape of a horizontal bar, and the front of the camera unit 3 is a plane portion 31 on which a camera 35 is installed, and the rear of the camera unit 3 is an arc portion 32 for back and forth rotation, a hinge 33 on one side connected to the camera unit 3 and the placement position 23, and the sleeve hole 34 on the other side connected to the camera unit 3 and the placement position 23, a center of the swivel hole 34 is provided for a wiring 351 configuration of the camera 35, the wiring 351 is pulled out to the POS machine 100 through the outlet hole 226 on the rear of the swivel seat 225.

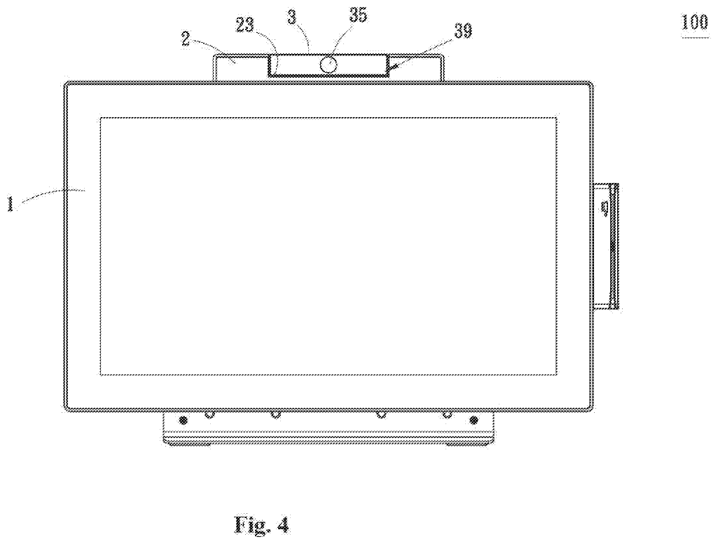

As shown in FIG. 1 and FIG. 4, the overall design structure of the invention is simple and practical, especially the design that the camera unit 3 can be turned over on both sides of a front end and a rear end, which is the greatest feature of the POS machine 100 of the invention. During application, utilize the recessed placement position 23 on the customer display screen 2 to pivotally connect the camera unit 3 horizontally, so that the camera unit 3 can be rotatably located on the customer display screen 2. When the POS machine 100 is to be opened for use, the camera unit 3 can be rotated backwards to the second rotational location 39, so that the camera unit 3 is higher than the main display screen 1, and the camera unit 3 is located in the same direction as the main display screen 1, when faces the cash register, it can simply perform image recognition and boot to avoid being disclosed the information confidentiality. It can speed up the booting operation and effectively ensure the safety protection for the information management of the people in contact with affairs.

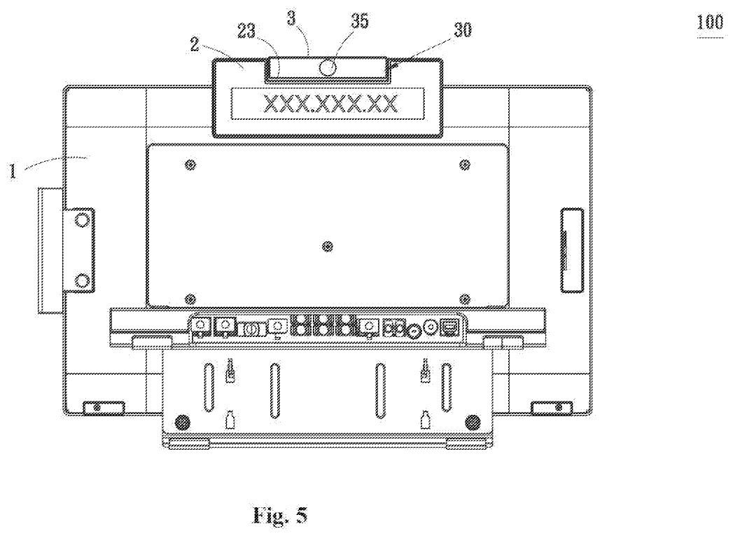

As shown in FIG. 1 and FIG. 5, when perform normal checkout and getting paid, the camera unit 3 can be rotated forward to the first rotational location 30, so that the camera unit 3 and the customer display screen 2 are located in the same direction. It can be used to implement sales payment and image big data collection on the customer side, so that customers can pay with their mobile phones to identify and scan the QR CODE, and collect and analyze the purchase information of gender, age, customer consumption time, and the purchase behavior of different customer groups, so that the business has more efficiently understand about the consumption tendency of customers, effectively eliminate unsalable products, and then quickly control the sales status and inventory status of various products, and even provide references for future product development.

Simultaneously, the camera unit 3 is effectively integrally integrated and pivoted on the customer display screen 2, so that the POS machine 100 composed of the invention can also recognize the facial features through the camera unit 3, thereby realizing the function of payment after scanning face, especially focus on the camera unit 3 of the present invention, because the camera unit 3 can easily turn up and down to adjust the angle, so the orientation of the camera 35 can be adjusted at any time according to the height of the customer or the position of the customer station, so as to prevent the customer from being blocked by the products on the cash register and unable to aim at the camera. The cash register checkout process is more convenient, faster and saves time.

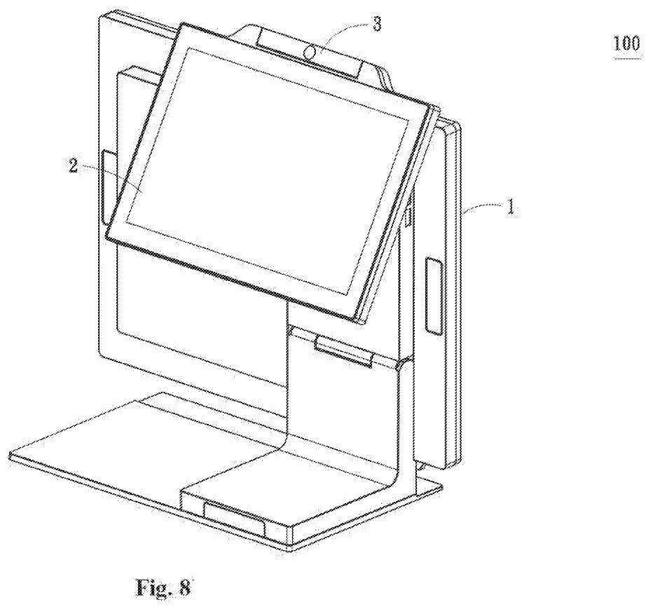

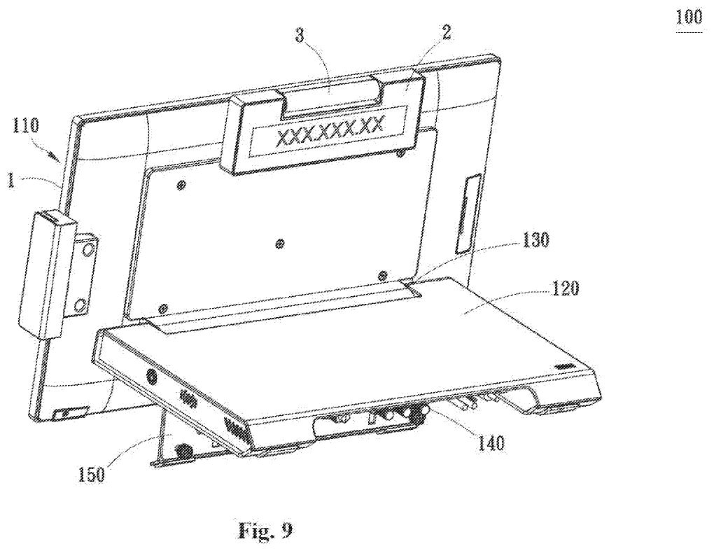

In a preferred embodiment, as shown in FIG. 8 and FIG. 9, wherein the customer display screen 2 can be formed by a VFD (vacuum fluorescent display) or an LCD (liquid crystal screen) customer display screen, but it is not limited thereto.

In a preferred embodiment, as shown in FIG. 9, wherein the POS machine 100 is further a folding terminal sale machine, comprises: at least one sales operation interface 110, and a mainframe module 120; wherein the sales operation interface 110 is in the shape of a flat plate, and a main display screen 1 is arranged on an outward side of the sales operation interface 110, the customer display screen 1 is arranged on an upper part of a back of the sales operation interface 110, and a lower part of the sales operation interface 110 is connected with the mainframe module 120 by a pivot joint 130, so that the sales operation interface 110 and the mainframe module 120 rotate mutually, change an angle to fold and cover inward or open outward; and the mainframe module 120 is provided with a main board electrically connected to the main display screen 1, the mainframe module 120 has an output/input connection port 140 that is arranged on an opposite side away from a hinge 33, wherein a bottom of the mainframe module 120 is further arranged with a raised bracket 150 for movable locking, and the raised bracket 150 is in the shape of a long Z shape on two sides of which has folding edges in different direction. By way of the new and enhanced structural design of the invention, it can meet the upgrading of the practical functions of the old products, inject new life into the series of products, expand the application requirements and further extend the market life of the products.

In summary, the invention is novel and practical and fully meets the requirements of a patent, and an application for a new patent is proposed. However, the foregoing is only a preferred embodiment of the present invention and should not limit the scope of implementation of the present invention; therefore, all equivalent changes and modifications made in accordance with the patent scope of the present invention and the content of the present invention specification that should be within the scope covered by the present invention patent.

What is claimed is:

1. A rotatable camera device for a POS machine, comprising:
a POS machine has a main display screen and a customer display screen, wherein the customer display screen is located behind the main display screen;
a camera unit is rotatably located on the customer display screen and has at least a first rotational location and a second rotational location;
the first rotational location is located in the same direction as the customer display screen, faces a customer end for sale payment and collection on an image big data; and
the second rotational location is located in the same direction as the main display screen, is higher than an upper end of the main display screen and faces a cash register for image recognition and booting.

2. The rotatable camera device of the POS machine as claimed in claim 1, wherein the customer display screen is composed of a VFD (vacuum fluorescent display) or an LCD (liquid crystal screen) for the customer display screen.

3. The rotatable camera device of the POS machine as claimed in claim 1, wherein the POS machine is a flat panel POS machine, and the customer display screen is recessed with a placement position to accommodate the horizontal pivoting of the camera unit, the rotational angle between the first rotational location and the second rotational location is at least 180 degrees.

4. The rotatable camera device of the POS machine as claimed in claim 1, wherein the customer display screen is composed of a front concave cover, a rear concave cover, and a digital display screen is clamped between the front concave cover and the rear concave cover, a display frame on the front concave cover to show the digital display screen, and a swivel seat is located on the rear of the rear concave cover, so that the swivel seat is rotated on a back of the main display screen, and an outlet hole is located on the swivel seat for connecting a wiring.

5. The rotatable camera device for the POS machine as claimed in claim 1, wherein the camera unit is in the shape of a horizontal bar, and the front of the camera unit is a plane portion on which a camera is installed, and the rear of the camera unit is an arc portion for back and forth rotation, a hinge on one side connected to the camera unit and a placement position, and a sleeve hole on the other side connected to the placement position and the camera unit, a center of the swivel hole is provided for a wiring configuration of the camera, the wiring is pulled out to the POS machine through an outlet hole on the rear of a swivel seat.

6. The rotatable camera device of the POS machine as claimed in claim 1, wherein the POS machine is further a folding terminal sale machine, comprises: at least one sales operation interface, and a mainframe module; wherein the sales operation interface is in the shape of a flat plate, and a main display screen is arranged on an outward side thereof, the customer display screen is arranged on an upper part of a back of the sales operation interface, and a lower part of the sales operation interface is connected with the mainframe module by a pivot joint, so that the sales operation interface and the mainframe module rotate mutually, change an angle to fold and cover inward or open outward; and the mainframe module is provided with a main board electrically connected to the main display screen, the mainframe module has an output/input connection port that is arranged on an opposite side away from a hinge.

7. The rotatable camera device of the POS machine as claimed in claim 6, wherein a bottom of the mainframe module is further arranged with a raised bracket for movable locking, and the raised bracket is in the shape of a long Z shape on two sides of which has folding edges in different direction.
